(19) United States
(12) Patent Application Publication
(10) Pub. No.: US 2017/0275056 A1
(43) Pub. Date: Sep. 28, 2017

(54) MAGNETIC LOCKING RECLOSURE FOR PACKAGES AND METHODS OF MAKING THE SAME

(71) Applicant: MAGNETNOTES, LTD., TOLEDO, OH (US)

(72) Inventors: RANDALL A. BOUDOURIS, SYLVANIA, OH (US); JAMES MICHAEL ACHENBACH, AUGUSTA, MO (US); LUKE L. RUNDQUIST, SYLVANIA, OH (US)

(73) Assignee: MAGNETNOTES, LTD., TOLEDO, OH (US)

(21) Appl. No.: 15/469,472

(22) Filed: Mar. 24, 2017

Related U.S. Application Data
(60) Provisional application No. 62/314,085, filed on Mar. 28, 2016.
(60) Provisional application No. 62/362,362, filed on Jul. 14, 2016.

(51) Int. Cl. B65D 33/24; B29C 65/48; B29C 47/08; B29C 47/88; B65D 33/25; B65D 65/40

(52) U.S. Cl. CPC B65D 33/24; B65D 33/25; B65D 65/40; B29C 47/0867; B29C 47/8805; B29C 65/48; B29L 2031/712

(57) ABSTRACT

A resealable package, the resealable package comprising a polymeric substrate, the polymeric substrate comprising a first side panel, a second side panel, a closed bottom and an opening, the opening comprising a first side region and a second side region and the first side region and the second side region comprise a magnetizable composition, the magnetizable composition comprises a thermoplastic polymer and magnetizable particles and the magnetizable composition is aligned and magnetized to form a first magnet along the first side region and a second magnet along the second side region. The first magnet comprises a plurality of poles having a first leading edge comprising a first pole and the second magnet comprises a plurality of poles having a second leading edge comprising a second pole that is opposite to the first pole.

### CROSS-REFERENCE TO RELATED APPLICATIONS

This application claims priority under 35 U.S.C. §119 to U.S. Provisional Application Ser. No. 62/314,085, filed Mar. 28, 2016, and to U.S. Provisional Application Ser. No. 62/362,362, filed Jul. 14, 2016, the entire disclosures of which are herein incorporated by reference.

### TECHNICAL FIELD

The present disclosure relates to a resealable packages and to methods of making the same, for example, a storage bag having a magnetic closure.

### BACKGROUND

An affordable magnetic re-closure feature has long been desired in the packaging industry. However, this has not yet been practical because of the difficulty and cost of applying traditional magnets to a package.

### SUMMARY

This disclosure provides design, material, manufacturing method, and use alternatives for magnetic re-closures.

In one aspect, the disclosure relates to a method of making a resealable package, the method comprising heating a magnetizable composition to a temperature at which the magnetizable composition is in flowable form, the magnetizable composition comprising at least one thermoplastic polymer material and magnetizable particles, extruding the magnetizable composition, aligning the magnetizable composition while the magnetizable composition is in flowable form, chilling the magnetizable composition, and magnetizing the magnetizable composition to form a first magnet and a second magnet. The first magnet comprises a plurality of poles having a first leading edge with a first pole and the second magnet comprises a second leading having a second pole that is opposite to the first pole.

Alternatively or additionally to any of the embodiments above, the method may include two or more of aligning, chilling and magnetizing are performed simultaneously.

Alternatively or additionally to any of the embodiments above, the method further comprises applying the magnetizable composition to a first side region and to a second side region of a polymeric substrate while the magnetizable composition is in flowable form.

Alternatively or additionally to any of the embodiments above, the method further comprises applying the magnetizable composition to a first side region and to a second side region of a polymer substrate after the magnetizable composition has been magnetized and securing the magnetizable composition to the polymer substrate by heat sealing or adhesively.

Alternatively or additionally to any of the embodiments above, the method further comprises applying the magnetizable composition to a first side region and to a second side region of a polymer substrate and magnetizing the magnetizable composition after application to the polymer substrate.

Alternatively or additionally to any of the embodiments above, the polymeric substrate is a resealable bag and the first side region and second side region define an opening of the resealable bag.

Alternatively or additionally to any of the embodiments above, the polymeric substrate is a resealable bag and the first side region and second side region define an opening of the resealable bag.

Alternatively or additionally to any of the embodiments above, the polymeric substrate is in a roll, the method further comprising unwinding the roll and applying the magnetizable composition to the first side region and the second side region of the roll during unwinding.

Alternatively or additionally to any of the embodiments above, the polymeric substrate is in a roll, the method further comprising unwinding the roll and applying the magnetizable composition to the first side region and the second side region of the roll during unwinding.

Alternatively or additionally to any of the embodiments above, the method comprises heating the magnetic composition to a temperature of about 150° C. to about 350° C.

Alternatively or additionally to any of the embodiments above, the magnetic composition comprises about 70% to about 95% magnetizable particles and about 5% to about 30% by weight polymer material.

Alternatively or additionally to any of the embodiments above, the first magnet and the second magnet each comprise about 4 to about 22 poles.

Alternatively or additionally to any of the embodiments above, the method comprises moving the substrate a rate of about 50 feet/minute to about 1000 feet/minute.

In another aspect, the present disclosure relates to a resealable package, the resealable package comprising a polymeric substrate, the polymeric substrate comprising a first side panel, a second side panel, a closed bottom and an opening, the opening comprising a first side region and a second side region and the first side region and the second side region comprise a magnetizable composition, the magnetizable composition comprises a thermoplastic polymer and magnetizable particles and the magnetizable composition is aligned and magnetized to form a first magnet along the first side region and a second magnet along the second side region. The first magnet comprises a plurality of poles having a first leading edge comprising a first pole and the second magnet comprises a plurality of poles having a second leading edge comprising a second pole that is opposite to the first pole.

Alternatively or additionally to any of the embodiments above, the resealable package has magnetic regions with a thickness of 5 mils to about 60 mils or about 125 microns to about 1525 microns.

Alternatively or additionally to any of the embodiments above, the resealable package is a bag.

Alternatively or additionally to any of the embodiments above, the polymeric substrate comprises a polyolefin, or a copolymer or terpolymer thereof.

Alternatively or additionally to any of the embodiments above, the polymeric substrate comprises polypropylene, high density polyethylene, medium density polyethylene, low density polyethylene, linear low density polyethylene, and copolymers thereof, polyesters and copolymers thereof, or mixtures thereof.

Alternatively or additionally to any of the embodiments above, the polymeric substrate comprises a metalized of foil laminated polyolefin.

Alternatively or additionally to any of the embodiments above, the magnetizable composition comprises about 80% to about 90% by weight magnetizable particles and about 10% to about 20% by weight polymer material.

Alternatively or additionally to any of the embodiments above, the magnetizable composition comprises at least one ethylene vinyl acetate copolymer.

These and other aspects, embodiments and advantages of the present disclosure will become immediately apparent to those of ordinary skill in the art upon review of the Detailed Description and Claims to follow.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

FIG. 1 is a perspective view of an example article in a closed state;

FIG. 2 is a perspective view of an example article in a partially opened state;

FIG. 3 is an exploded perspective view of an article in an opened state;

FIG. 4 is an view of an example article, depicting a seal;

FIG. 5 is a schematic view of two portions of a package having the printable, magnetizable, hot melt coating of this disclosure applied thereto form a plurality of A magnets and B magnets, wherein the outer edges of the A magnets are provided with north pole magnetic orientations and the outer edges of the B magnets are provided with south pole magnetic orientations.

FIG. 6 is a perspective view of an example article in an open state;

FIG. 7 is a perspective view of an example article in an open state;

FIG. 8 is a partial perspective view of an example magnetic closure in a partially opened state;

FIG. 9 is a partial perspective view of an example magnetic closure in a partially opened state;

FIG. 10 is a partial perspective view of an example magnetic closure in a partially opened state;

FIG. 11 is a partial perspective view of an example magnetic closure in a closed state; and

FIG. 12 is a flow chart illustrating exemplary processes according to the present disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the disclosure.

This disclosure relates in general to magnetic re-closures for packages including flexible packaging such as polymeric bags, and boxes and cartons. In particular, this disclosure relates to a printable hot melt magnetic re-closure that is simple and inexpensive to apply to a package, and more particularly to articles employing magnetic snap-lock closures, in particular, bags, cartons or boxes employing magnetic snap-lock closures.

For example, a printable hot melt magnetic re-closure may be directly printed onto a substrate in a molten state without the use of any adhesive, or may alternatively be applied in a cooled state with the use of adhesive, or through a heat bonding method. Magnetizable compositions can be printed in a relatively thin coating at high speeds, and can be magnetically aligned, to maximize the magnetic holding force.

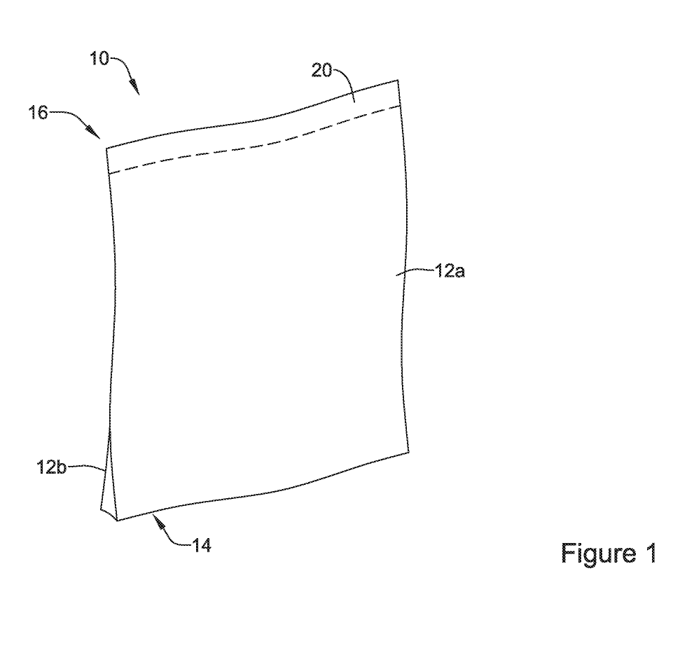

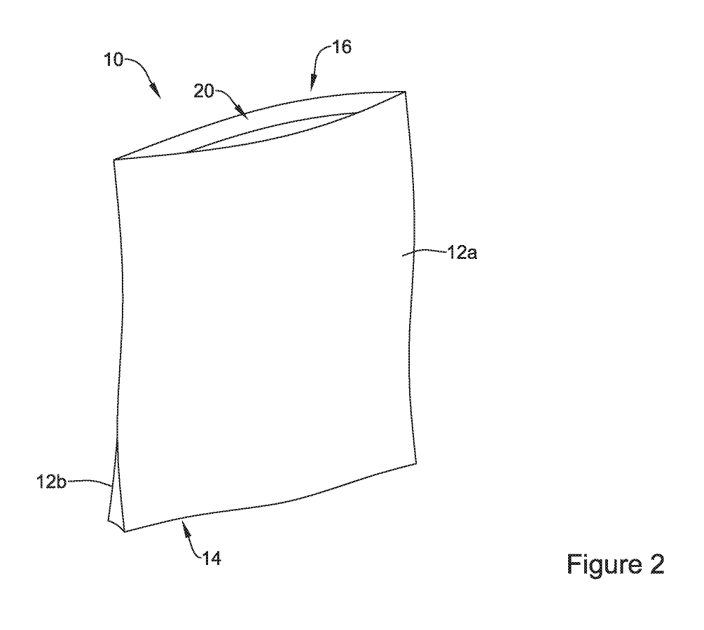

Turning now to the figures, FIG. 1 illustrates an example article, in this embodiment, a resealable bag or container 10, that may be formed in accordance with the present disclosure. Bag 10 is shown in closed state and has two side panels 12a/12b, a first end region 14, and a second end region 16. In this example, first end region 14 is a closed end that may be positioned at the bottom of bag 10. Second end region 16 may include a magnetic closure or seal 20, depicted in phantom in FIG. 1, and second end region 16 is designed to be opened and closed/sealed. FIG. 2 illustrates bag 10 in a partially open state where the second end region 16 is open and a portion of magnetic seal 20 can be seen. While bag 10 is depicted as being generally rectangular in shape, with two generally opposing, symmetrical side panels 12a/12b, other shapes and configurations are contemplated including configurations that include additional/different side panels, additional/different end regions, different shapes (e.g., polygonal, rounded, oval, irregular, etc.), and the like.

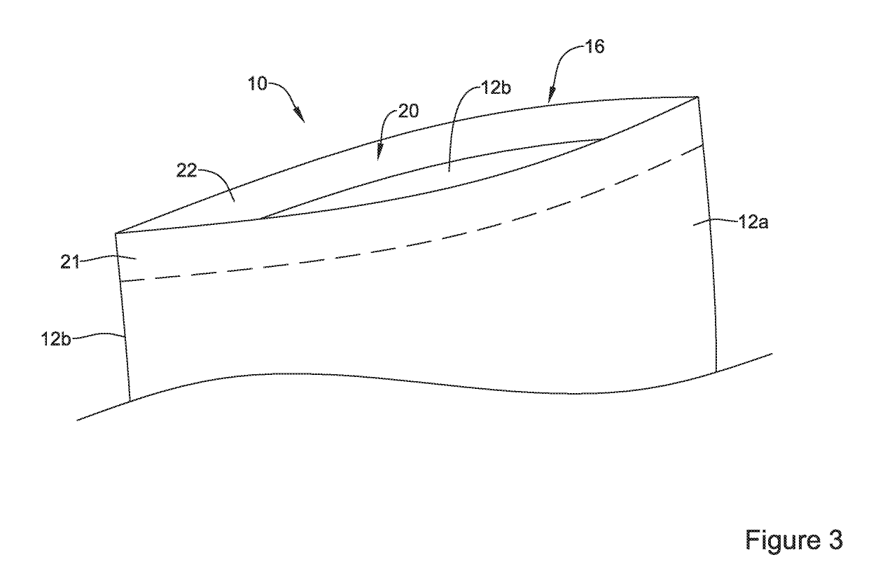

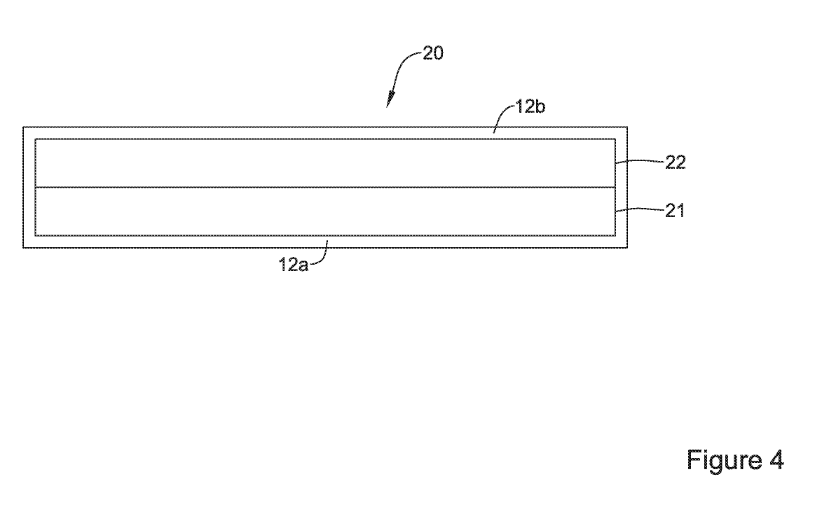

FIG. 3 is a partial view of bag 10 adjacent to second end region 16 with magnetic seal 20 in an opened state. Here it can be seen that magnetic seal 20 may include a first magnet or magnetic member 21, for example positioned adjacent to an end region one of the side panels 12a, and a second magnetic or magnetic member 22, for example positioned adjacent to an end region of the other one of the side panels 12b. First magnetic member 21 and second magnetic member 22 can be brought together to seal bag 10 as depicted schematically in FIG. 4.

The magnetic members 21, 22 are each formed from a magnetizable material including at least one thermoplastic material and magnetizable particles. The thermoplastic materials and the magnetizable particles are described in more detail below. Alternatively, the magnetizable material may include a thermoset material and magnitizable particles.

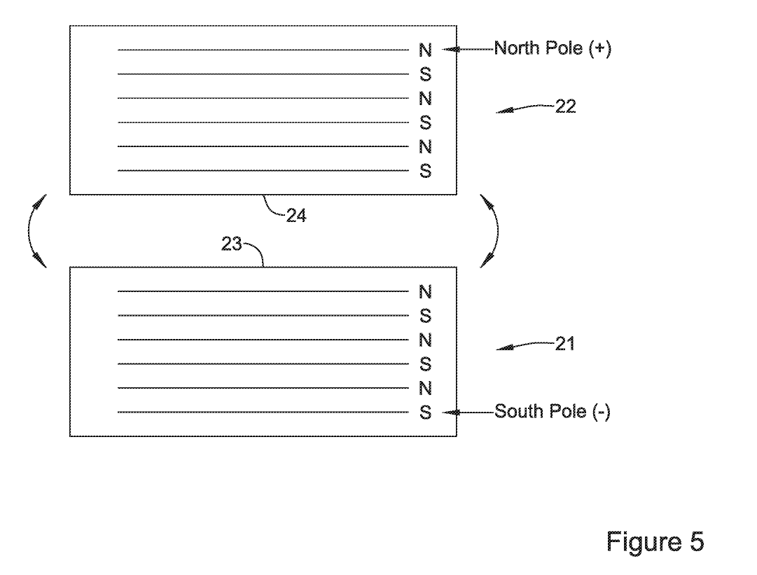

The magnetic members 21, 22 may have each from between one north pole and one south pole to 30 poles for each magnetic members 21, 22. In some instnaces, the magnetic members 21, 22 are multipole magnets, each magnetic members 21, 22 having from 1 to 22 poles per magnet or about 4 to 22 poles per magnet. For example, an arrangement where magnetic member 21 constitutes a single magnet having a north pole and magnetic member 22 constitutes a single magnet having a south pole, for example, those made from neodymium may be formed this way, or an arrangement where magnetic member 21 constitutes a magnet and magnetic member 22 constitutes a magnetic receptive material. The scope of the disclosure is not limited by the arrangement of the magnetic members 21, 22 provided that magnetic members 21, 22 are magnetically attracted to one another. Alternatively, FIG. 5 illustrates an example where magnetic member 21 and magnetic member 22 each include 7 poles. In this example, a leading edge 23 of magnetic member 21 is provided with a south pole magnetic orientation, and a leading edge 24 of magnetic member 22 is provided with a north pole magnetic orientation. As a result, when the bag 10 is closed (e.g., as shown in FIG. 1), the magnetic orientation of magnetic member 21 and magnetic member 22 are in the proper position with flush edges as shown in FIG. 4 so as to magnetically retain the cooperating portions of the package adjacent to one another during use. These arrangements are intended as illustrative only, and not as a limitation on the scope of the disclosure. Other arrangements and magnetic orientations not specifically described herein are also contemplated.

Bag 10 (and/or other bag, container, etc. disclosed herein) may be formed from a suitable polymer materials including durable, recyclable and biodegradable polymer materials. Examples of durable or recyclable polymer materials include, but are not limited to, polyolefins and copolymers or terpolymers thereof, for example, polypropylene and polyethylene including HDPE, MDPE, LDPE and LLDPE, polyesters and copolymers thereof, for example, polyethylene terephthalate (PET), and so forth. An example of a suitable bioplastic or biodegradable material is polylactic acid.

Bag 10 may also be laminated. For example, some bags are formed from a metalized or foil laminated polypropylene, for example, aluminum laminated polypropylene.

Bags may be formed by blown film extrusion of a roll of sheet material as is known in the art. This will be explained in more detail below with respect to application of the magnetic seal 20 to bag 10.

Alternatively, the resealable packages may be formed from paper, paper products or pasteboard, for example, paperboard or cardboard, and laminated versions thereof.

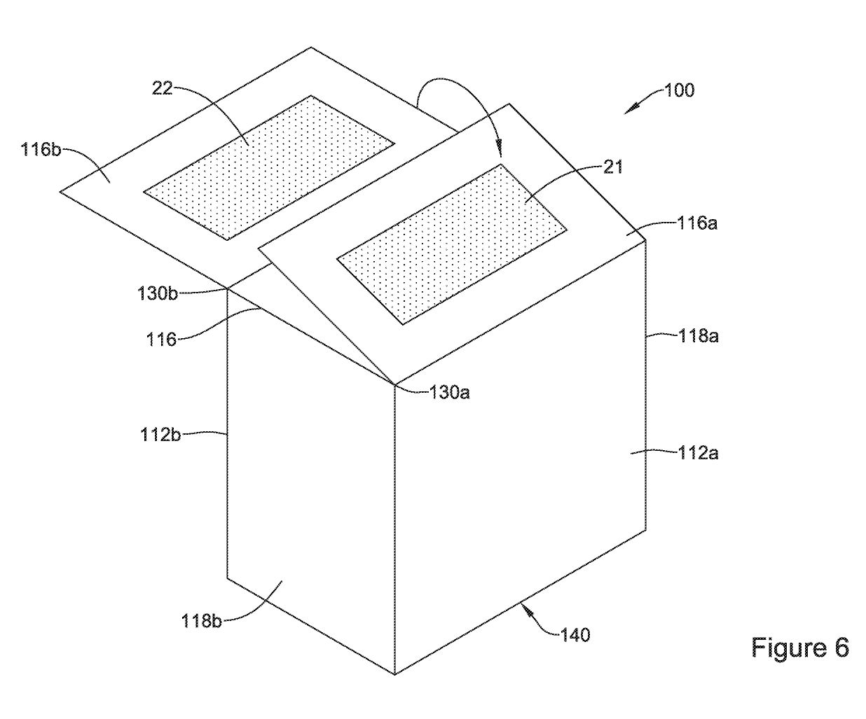

FIG. 6 is a perspective view of one embodiment of a magnetically reclosable package, for example, a box or carton 100, according to the present disclosure. In this embodiment, package 100 has a basic box configuration with opposing front and back panels 112a, 112b respectively, connected by opposing sides 118a, 118b. Box 100 also has a bottom 114 and an open top 116 having two opposing side flaps 116a, 116b which fold inward at folds 130a, 130b respectively to close box 100. Magnetic strip 22 of flap 116b when folded down at a fold 130b aligns with magnetic strip 21 of flap 116a when flap 116a is folded down at fold 130a to securely close package 100.

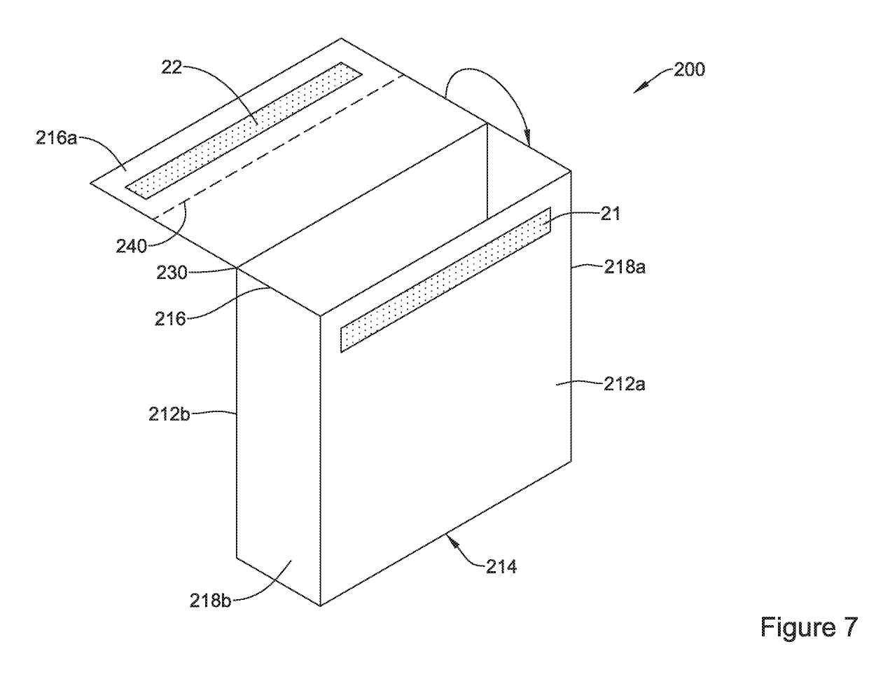

FIG. 7 is an exemplary package, for example, a box or carton 200 which is formed of one or more foldable blanks. In this embodiment, one foldable blank is employed. Box 200 includes a front and back panel 212a, 212b respectively, connected by opposing side portions 218a, 218b. In this embodiment, front panel 212a includes a magnet strip 21, and optionally a slit (not shown). The top portion 216 includes a flap 216a having a magnetic strip 22. Top portion 216 folds at 240 such that the magnetic strip 22 of flap 216a overlaps with the magnetic strip 21 of the front panel 212 a, which secures the package 200 in a closed state.

Alternatively, box 200 can be formed of one or more foldable blanks, for example, including a bottom portion having opposing sides and an inner foldable blank disposed within box 200. Box 200 may include a top portion having opposing sides and a front and back panel, the top of which opens and closes. The inner surface of the front panel may include a magnetic strip 22 which overlaps magnetic strip 21 when the top is closed. The inner foldable blank may also include a cut out portion for more easily retrieving items when the top is open. The above embodiments and features are intended for illustrative purposes, and not as a limitation on the scope of the present application.

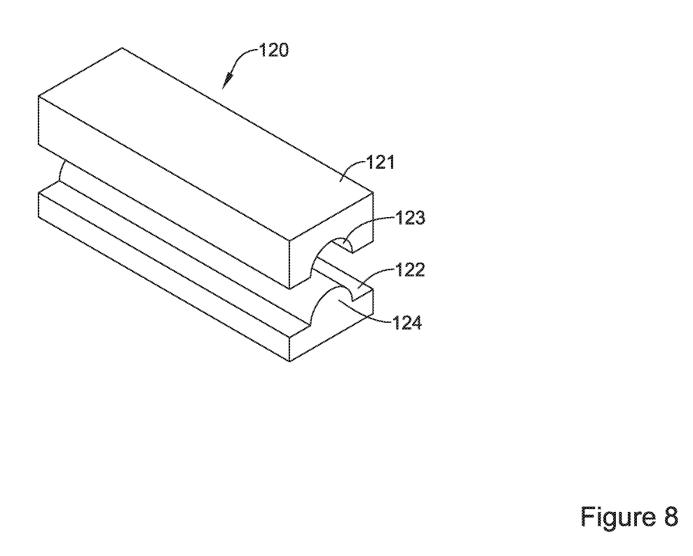

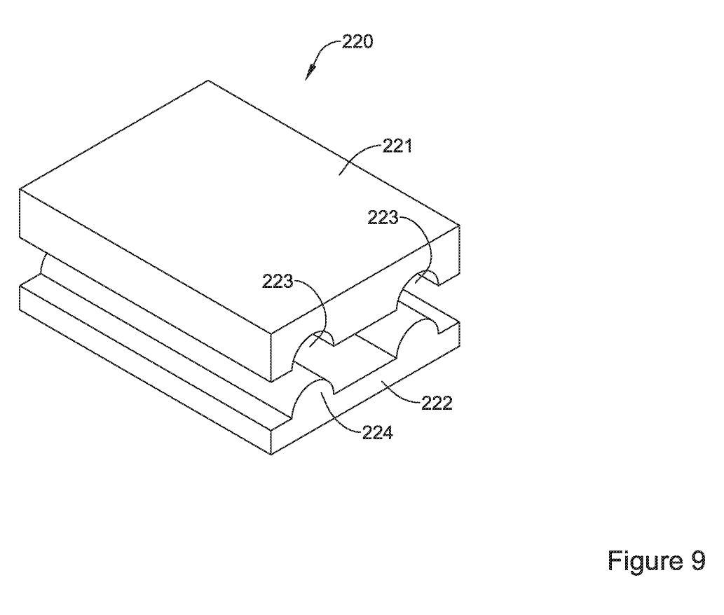

FIG. 8 is a perspective view of an alternative example magnetic seal 120 that may be similar in form and function to other seal disclosed herein. In this example, magnetic seal 120 includes first magnetic member 121 having a channel or groove 123 and a second magnetic member 122 having a corresponding ridge 124 wherein the groove 123 and the ridge 124 form an interlocking or interference fit which increases the surface area contact between magnetic member 121 and magnetic member 122, resulting in a more intimate and stronger seal. FIG. 9 is a perspective view of an alternative example magnetic seal 220 that may be similar in form and function to other seal disclosed herein. In this example, magnetic seal 220 includes first magnetic member 221 having two channels 223 and a second magnetic member 222 having two corresponding ridges 224, further increasing the surface area contact between magnetic members 221, 222.

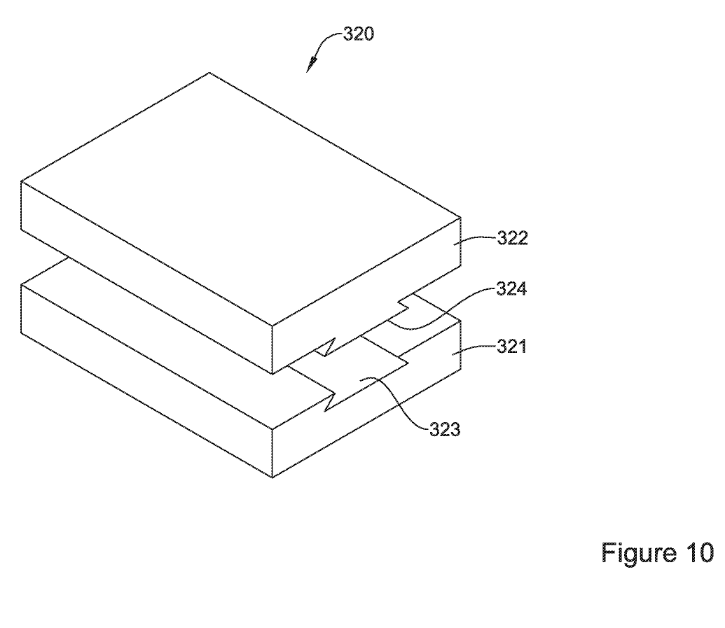

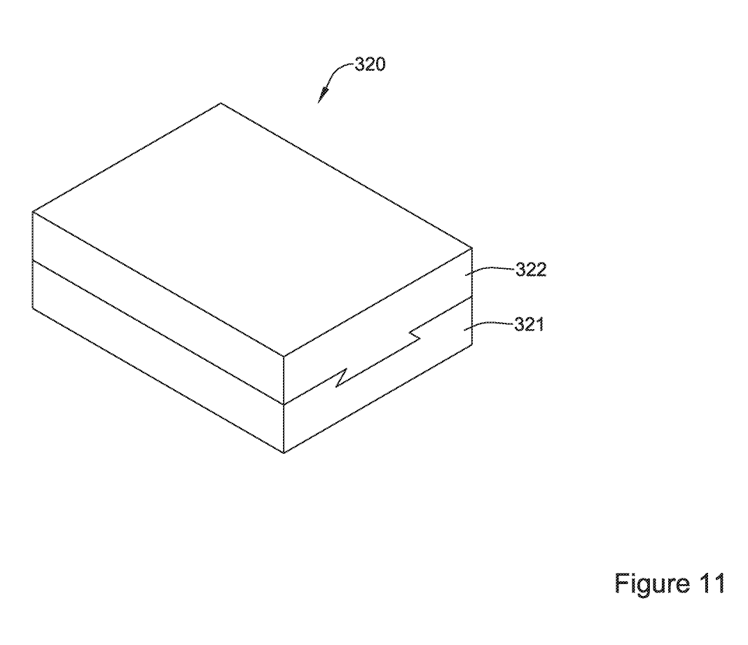

FIG. 10 is a perspective view of an alternative example magnetic seal 320 that may be similar in form and function to other seal disclosed herein. In this example, magnetic seal 320 includes a first magnet member 321 having a channel 323 and a second magnetic member 322 having a corresponding ridge 324 which in this case requires what can be described as a zipper lock. The second magnetic member 322 having ridge 324 that can be slid into the channel 323 of the first magnetic member 321 as shown in FIG. 11.

The magnetizable composition forming the magnetic seal 20 (e.g., for each of the magnetic members disclosed herein) suitably includes about 70 wt-% or more of the magnetizable particles as to have a sufficient attractive force for practical uses. However, it is usually impractical to employ more than 95 wt-% of the magnetizable particles because of production concerns, and also because of the difficulty of retaining more than this in the binder material. Furthermore, including more than about 95 wt-% of the magnetic material may lead to a rougher surface.

Suitably, the magnetizable composition comprises about 70 wt-% to about 95 wt-% of the magnetizable particles and about 5 wt-% to about 30 wt-% of at least one polymer material. In some embodiments, the magnetizable composition comprises about 80 wt-% to about 90 wt-% of the magnetizable particles and about 10 wt-% to about 20 wt-% of at least one polymer material. In some embodiments, the magnetizable composition comprises about 75 wt-% to about 91 wt-% polymer material and about 25 wt-% to about 9 wt-% magnetizable particles. In some embodiments, the magnetizable composition comprises about 84 wt-% to about 90 wt-% polymer material and about 16 wt-% to about 10 wt-% magnetizable particles.

The thermoplastic material, often referred to in the industry as a thermoplastic binder, suitable for use in the process of the present disclosure may include any polymeric material that is readily processable with the magnetic material on, for instance, the thermoplastic or hot melt processing equipment as described in detail below. Such thermoplastic materials include both thermoplastic elastomers and non-elastomers or any mixture thereof.

The thermoplastic composition may be selected based on, for one, the type of printable substrate which is being used, and the adhesion obtained between the thermoplastic composition and the printable substrate.

Examples of thermoplastic elastomers suitable for use herein include, but are not limited to, natural and synthetic rubbers and rubbery block copolymers, such as butyl rubber, neoprene, ethylene-propylene copolymers (EPM), ethylene-propylene-diene polymers (EPDM), polyisobutylene, polybutadiene, polyisoprene, styrene-butadiene (SBR), styrene-butadiene-styrene (SBS), styrene-ethylene-butyl ene-styrene (SEBS), styrene-isoprene-styrene (SIS), styrene-isoprene (SI), styrene-ethylene/propylene (SEP), polyester elastomers, polyurethane elastomers, to mention only a few, and so forth and mixtures thereof. Where appropriate, included within the scope of this disclosure are any copolymers of the above described materials.

Examples of suitable commercially available thermoplastic elastomers such as SBS, SEBS, or SIS copolymers include KRATON® G (SEBS or SEP) and KRATON® D (SIS or SBS) block copolymers available from Kraton Polymers; VECTOR® (SIS or SBS) block copolymers available from Dexco Chemical Co.; and FINAPRENE® (SIS or SBS) block copolymers available from Atofina.

Some examples of non-elastomeric polymers include, but are not limited to, polyolefins including polyethylene, polypropylene, polybutylene and copolymers and terpolymers thereof such as ethylene vinyl acetate copolymers (EVA), ethylene n-butyl acrylates (EnBA), ethylene methyl (meth) acrylates including ethylene methyl acrylates (EMA), ethylene ethyl (meth) acrylates including ethylene ethyl acrylates (EEA), interpolymers of ethylene with at least one C₃ to C₂₀ alphaolefin, polyamides, polyesters, polyurethanes, to mention only a few, and so forth, and mixtures thereof. Where appropriate, copolymers of the above described materials also find utility herein.

Examples of polymers useful herein may be found in U.S. Pat. No. 6,262,174 incorporated by reference herein in its entirety. Polymeric compositions exhibiting high hot tack have been found to be particularly suitable for use herein. Hot tack is a term of art known to those of ordinary skill.

Examples of commercially available non-elastomeric polymers include EnBA copolymers available from such companies as Atofina under the tradename of Lotryl® available from Arkema in the King of Prussia, Pa., from ExxonMobil Chemical in Houston, Tex. under the tradename of Escorene™, from DuPont de Nemours & Co. in Wilmington, Del. under the tradename of Elvaloy®; EMA copolymers available from ExxonMobil Chemical under the tradename of Optema™; EVA copolymers are available from DuPont™ under the tradename of Elvax® and from Lyondell Blassell in Houston, Tex. under the tradename of Ultrathene® to name only a few.

Polyolefins or polyalphaolefins can be employed herein, or copolymers or terpolymers thereof. Examples of useful polyolefins include, but are not limited to, amorphous (i.e. atactic) polyalphaolefins (APAO) including amorphous propylene homopolymers, propylene/ethylene copolymers, propylene/butylene copolymers and propylene/ethylene/butylene terpolymers; isotactic polyalphaolefins; and linear or substantially linear interpolymers of ethylene and at least one alpha-olefin including, for instance, ethylene and 1-octene, ethylene and 1-butene, ethylene and 1-hexene, ethylene and 1-pentene, ethylene and 1-heptene, and ethylene and 4-methyl-1-pentene and so forth. In some embodiments, a small amount of another polymer may be used in combination with the polyalphaolefin such as maleic anhydride grafted polymers which have been used to improve wetting and adhesion. Other chemical grafting can be used, but maleic anhydride is by far the most common. Usually only a few percent in grafting (1-5%) are used and most tend to be ethylene or propylene copolymers.

Thermoset polymer materials may also be employed which are cured in a variety of manners such as moisture cure, radiation cure, two-part chemical reactions, heat, and so forth to form substantially insoluble or infusible materials. Such materials are well known in the art.

Thermoset polymers crosslink and/or polymerize by energy or by chemical means and by a wide variety of mechanisms including, but not limited to, moisture cure, thermal and radiation cure, condensation, free radical systems, oxidative cures, etc. as well as combinations thereof.

Some examples of suitable thermoset materials include, but are not limited to, polyurethanes, polyureas, polyurethane/polyurea hybrids, epoxies, acrylics, polyesters, (meth)acrylates, cyanoacrylates, silicones (polysiloxanes), polyolefins and copolymers thereof such as ethylene vinyl acetate copolymers, rubbers including rubbery block copolymers, etc.

Each of class of thermoset material may come in a variety of different systems, including, for example, one and two part systems, and radiation curing systems such as radiation (e.g. UV) curing systems, moisture cure, etc.

In some embodiments, the magnetic composition includes a multicomponent epoxy or urethane thermoset composition. The thermoset polymer compositions may also be employed in combination with magnetic receptive particle materials.

In some embodiments, the thermoset polymer composition is cured using electron beam (e-beam) radiation. Crosslinking of polymer based products via e-beam radiation improves mechanical, thermal and chemical properties. Specifically, thermal resistance to temperature degradation and aging and low temperature impact resistance are improved.

Tensile strength, modulus, abrasion resistance, resistance to creep, stress crack resistance, resistance to high pressure, and so forth are increased.

Polymers which are commonly crosslinked using the electron beam irradiation process include polyvinyl chloride (PVC), thermoplastic polyurethanes and elastomers (TPUs), polybutylene terephthalate (PBT), polyamides/nylon (PA66, PA6, PA11, PA12), polyvinylidene fluoride (PVDF), (meth)acrylates, polymethylpentene (PMP), polyethylenes (LLDPE, LDPE, MDPE, HDPE, UHMWPE), and ethylene copolymers such as ethylene-vinyl acetate (EVA) and ethylene tetrafluoroethylene (ETFE). Some of the polymers utilize additives to make the polymer more readily irradiation crosslinkable.

The above thermoset materials may include monomers, dimers, oligomers and polymers, as well as combinations thereof as is known to those of ordinary skill in the art.

Other suitable additives can be employed in the magnetizable composition as well such as antioxidants and processing aids. One of ordinary skill in the art is knowledgeable as to hot melt additives.

The material used to form the printable, magnetizable, hot melt coating of this re-closure can be formed from any desired material or combination of materials. For example, various types of ferrites, strontium, neodymium, samarium cobalt may be used.

In some embodiments, neodymium, strontium ferrite or samarium cobalt or some combination thereof is employed.

Any magnetic material may be employed herein. Magnetic materials which are particularly suitable for use herein include the ferrites having the general formula (M²⁺O6Fe₂O₃) MFe₁₂O₁₉ where M represents Ba or Sr.

Other examples of magnetic materials suitable for use herein include a rare earth-cobalt magnet of RCO₅ where R is one or more of the rare earth elements such as Sm or Pr, yttrium (Y), lanthanum (La), cerium (Ce), and so forth.

Other specific examples of magnetic materials include, for instance, manganese-bismuth, manganese-aluminum, and so forth.

The viscosity of the magnetizable composition may range from about 5000 cPs to about 500,000 cPs.

The above lists are intended for illustrative purposes only, and not as a limitation on the present disclosure. It is within purview of those of ordinary skill in the art to select other polymers without departing from the scope of this disclosure.

The polymer material and the magnetizable particles can be added to and melted in mixer or an extruder, or can be supplied in the form of pre-made pellets.

The magnetic strength of the finished product is a function of the amount of magnetic material or powder in the mix, the surface area, thickness, and method of magnetization (e.g. whether it is aligned or not).

Coating thicknesses of the magnetic members 21, 22 may range from about 5 mils to about 60 mils, for example 10 mils to about 40 mils, and about 15 mils to about 25 mils. In some embodiments, the coating thickness is about 15 mils.

The method of the present disclosure is not limited to any particular magnetic material, and the scope of the disclosure is therefore not intended to be limited as such. While the above described materials find particular utility in the process of the present disclosure, other materials which are readily permanently magnetized may also find utility herein.

The magnetizable composition is heated to a temperature at which it is molten or flowable using any suitable hot melt or thermoplastic equipment. The mixture is then supplied to a melt pump or small extruder via any suitable means such as an auger.

The compositions according to the disclosure can be applied to the moving substrate 12 at a high rate of line speed of from about 50 feet/minute to about 1000 feet/minute, suitably greater than about 80 feet/minute to about 500 feet/minute.

A rare earth magnet can be used to magnetize the material used to form the printable, magnetizable, hot melt coating of this re-closure. The magnetizer can be between two poles per inch and twenty-six poles per inch. The magnetizer may be built around a drum and internally cooled. The coated material may be maintained at peak magnetizing temperatures using a heat tunnel or other suitable means of supplying heat. The magnetizer may, for example, be formed from neodymium or samarium cobalt. In some embodiments, the operating temperature of the magnetizer should not exceed 225° F. (about 110° C.).

In some embodiments, the magnetizable composition may be magnetized in a temperature range from about 150° F. to 500° F. (about 65° C. to about 260° C.).

The magnetizable composition is suitably cooled while during exposure to the aligning magnetic field. One or more external cooling units may be used to cool the material used to form the printable, magnetizable, hot melt coating of this re-closure while it is in the magnetic field. In some embodiments, a release surface or a thin liner is provided between the magnetizer and such material.

In some embodiments a chill roll that is wrapped in magnets such as neodymium magnets is employed. Strontium ferrite and samarium cobalt may also be employed alone or in combination with neodymium magnets. Other examples of suitable magnets include, but are not limited to, neodymium ferrite, barium ferrite, and lead ferrite. The molten magnetizable composition may be aligned, chilled and magnetized in a single step as it winds around the chill roll.

Depending on the form of the magnetic strips, the strips may be applied either by extrusion to the sheet material, or the magnetic zip lock may be preformed into strips and then applied to the sheet material with a heat bond between about 350° F. and about 475° F., more typically about 355° F. to about 465° F. or adhered to the bags using an adhesive material.

The bags are then cut, and the edges of the bags are heated sealed including the bottom and the sides of the bags.

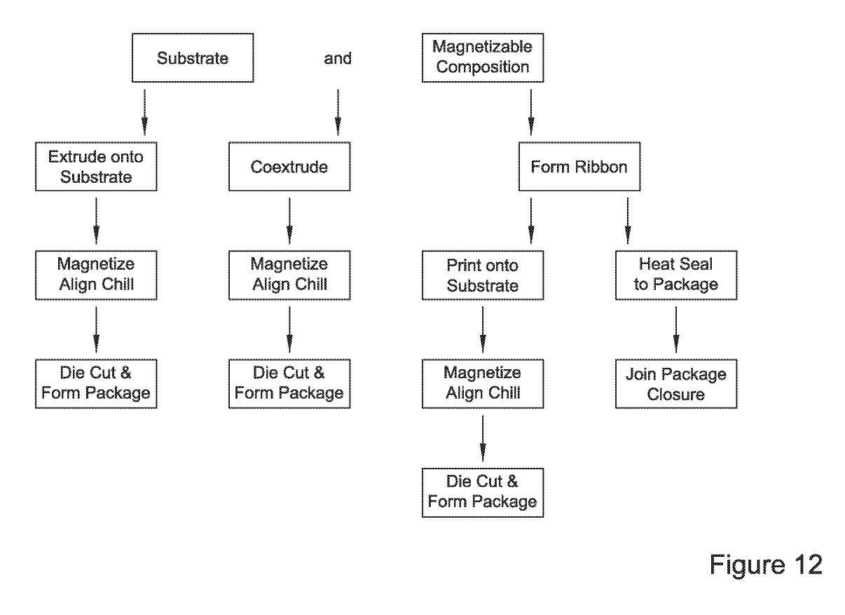

FIG. 12 is illustrative of a variety of processing methods which may be employed herein. In some embodiments, the magnetizable composition is heated until molten, and is extruded onto a moving substrate, for example, using a slot die head. Two strips or ribbons of magnetizable composition may be applied to opposing edges of the moving substrate, for example. The magnetizable composition is then aligned, magnetized and chilled. The aligning, magnetizing and chilling may be done simultaneously using a magnetic chill roll as discussed above, or may be done individually or in some combination thereof. The substrate is then die cut to form a package such that the magnetic strips are located at opposing sides of a top opening of the package, and the magnetic strips are joined.

In some embodiments, the substrate may be a polymeric substrate, and the polymeric substrate and the magnetizable composition may be coextruded, again having the magnetizable composition applied at either edge of the substrate. The magnetizable composition is again aligned, magnetized and chilled, and the substrate is then die cut, formed into a package, so as to have opposing magnetic strips at a top opening of the package, and the magnetic strips are joined.

In some embodiments, the magnetizable composition is extruded by itself to form a strip or ribbon which may be wound onto a roll or may be directly printed onto a moving substrate. The magnetizable composition is then aligned, magnetized and chilled, and the substrate is die cut to form a package having a top opening with magnetic strips on opposing sides of the top opening of the substrate. Alternatively, if the magnetizable composition is wound onto a roll, it may be later heat sealed or otherwise adhered to edges of a substrate, or to opposing edges at the top opening of an already formed package such as bag or box.

Optionally, for any of the embodiments above, the magnetizable composition may be magnetized after application to a substrate or package.

The resealable packages formed according to the present disclosure may be employed for storage of any of a variety of items as well as for prepackaged food products such as chips, crackers, cereal, frozen foods such as frozen fruits and vegetables and so forth.

The description provided herein is not to be limited in scope by the specific embodiments described which are intended as single illustrations of individual aspects of certain embodiments. The methods, compositions and devices described herein can comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims.

U.S. Pat. No. 7,501,921 is incorporated herein by reference herein in its entirety. U.S. Pat. No. 7,128,798 to Boudouris et al., U.S. Pat. No. 7,338,573 to Boudouris et al., U.S. Pat. No. 7,501,921 to Boudouris et al., and United States Patent Application No. 2006/0165880 to Boudouris et al., are all incorporated herein by reference.

All published documents, including all U.S. patent documents and U.S. patent publications, mentioned anywhere in this application are hereby expressly incorporated herein by reference in their entirety. Any copending patent applications, mentioned anywhere in this application are also hereby expressly incorporated herein by reference in their entirety. Citation or discussion of a reference herein shall not be construed as an admission that such is prior art.

1. A method of making a resealable package, the method comprising:
a) heating a magnetizable composition to a temperature at which the magnetizable composition is in flowable form, the magnetizable composition comprising at least one thermoplastic polymer material and magnetizable particles;
b) extruding the magnetizable composition;
c) aligning the magnetizable composition while the magnetizable composition is in flowable form;
f) chilling the magnetizable composition; and
g) magnetizing the magnetizable composition to form a first magnet and a second magnet;
wherein the first magnet comprises a plurality of poles having a first leading edge with a first pole and the second magnet comprises a second leading having a second pole that is opposite to the first pole.

2. The method of claim 1, wherein two or more of aligning, chilling and magnetizing are performed simultaneously.

3. The method of claim 1, further comprising applying the magnetizable composition to a first side region and to a second side region of a polymer substrate after the magnetizable composition has been magnetized and securing the magnetizable composition to the polymer substrate by heat sealing or adhesively.

4. The method of claim 1, further comprising applying the magnetizable composition to a first side region and to a second side region of a polymeric substrate while the magnetizable composition is in flowable form.

5. The method of claim 4, wherein the polymeric substrate is a resealable bag and the first side region and the second side region define an opening of the resealable bag.

6. The method of claim 4, wherein the polymeric substrate is a resealable bag and the first side region and the second side region define an opening of the resealable bag.

7. The method of claim 4, wherein the polymeric substrate is in a roll, the method further comprising unwinding the roll and applying the magnetizable composition to the first side region and the second side region of the roll during unwinding.

8. The method of claim 4, wherein the polymeric substrate is in a roll, the method further comprising unwinding the roll and applying the magnetizable composition to the first side region and the second side region of the roll during unwinding.

9. The method of claim 4, comprising moving the polymeric substrate a rate of about 50 feet/minute to about 1000 feet/minute.

10. The method of claim 1, comprising heating the magnetizable composition to about 150° C. to about 350° C.

11. The method of claim 1, wherein the magnetizable composition comprises about 70% to about 95% by weight of the magnetizable particles and about 5% to about 30% by weight of the polymer material.

12. The method of claim 1, wherein the first magnet and the second magnet each comprise about 4 to about 22 poles.

13. A resealable package, the resealable package comprising:
a polymeric substrate, the polymeric substrate comprising a first side panel, a second side panel, a closed bottom and an opening;
the opening comprising a first side region and a second side region; and
the first side region and the second side region comprise a magnetizable composition, the magnetizable composition comprises a thermoplastic polymer and magnetizable particles; and
the magnetizable composition is aligned and magnetized to form a first magnet along the first side region and a second magnet along the second side region;
wherein the first magnet comprises a plurality of poles having a first leading edge comprising a first pole and the second magnet comprises a plurality of poles having a second leading edge comprising a second pole that is opposite to the first pole.

14. The resealable package of claim 13, wherein the thickness of the first magnet, the second magnet, or both is about 5 mils to about 60 mils.

15. The resealable package of claim 13, wherein the resealable package is a bag.

16. The resealable package of claim 13 wherein the polymeric substrate comprises a polyolefin, or a copolymer or terpolymer thereof.

17. The resealable package of claim 13, wherein the polymeric substrate comprises polypropylene, high density polyethylene, medium density polyethylene, low density polyethylene, linear low density polyethylene or mixtures thereof.

18. The resealable package of claim 13, wherein the polymeric substrate comprises a metalized of foil laminated polyolefin.

19. The resealable package of claim 13, wherein the magnetizable composition comprises about 80% to about 90% by weight of the magnetizable particles and about 10% to about 20% by weight of the polymer material.

20. The resealable package of claim 13, wherein the magnetizable composition comprises at least one ethylene vinyl acetate copolymer.
